(19) United States
(12) Patent Application Publication
(10) Pub. No.: US 2021/0090009 A1
(43) Pub. Date: Mar. 25, 2021

(54) METAL FABRICATION INSPECTION AND RECORD SYSTEM

(71) Applicant: Dennis Johnson, Elm Grove, WI (US)

(72) Inventor: Dennis Johnson, Elm Grove, WI (US)

(21) Appl. No.: 16/577,533

(22) Filed: Sep. 20, 2019

(51) Int. Cl. G06Q 10/08

(52) U.S. Cl. CPC G06Q 10/087; G01N 29/04

(57) ABSTRACT

A quality control and inventory system for metal fabrication projects is disclosed comprising a plurality of material data comprising a plurality of materials input via a user interface to a database in communication with a computing device via a server. The plurality of material data includes a piece mark to specify each item of the plurality of materials. A plurality of quality control inspection data includes a plurality of quality control tests and associated with a result of the quality control inspection test.

### TECHNICAL FIELD

The embodiments generally relate to electronic inspection and record systems and more specifically related to electronic inspection and record systems for metal fabrication projects.

### BACKGROUND

General construction and metal fabrication projects often require a synchronized and collective effort from a large team including fabricators, project managers, material suppliers, and the like. Various raw materials are sourced and acquired before the project can be completed. Often, each raw material item must be inventoried and inspected for quality before it can be utilized by the fabricator.

Currently, the industry predominantly utilizes paper records to record inspection results for each raw material item. The use of paper records results in lost inventory and a loss of time as fabricators or other individuals must accurately record and store records for each piece of raw material. In particular, large projects often have an increased burden due to the high amount of inventory and material usage, which compounds the inconvenience of using paper records. Further, paper records are not easily amendable and do not allow for the input of additional data, such as quality test results, which would often be useful for fabricators. Manual record-keeping requires the observer of the records to be at the location where the records are stored, which may be inconvenient if the fabricator is operating at a remote location or if the material item is not stored in the same location as the records.

For example, raw materials commonly used in metal fabrication include plate metal, formed and expanded metal, tube stock, welding wire, welding rods, and casting. Each raw material item should be associated with a job number, piece mark, and an indication as to whether or not the item has passed an inspection. Fabricators must reference the records to determine if an item is suitable for use. Similarly, equipment inspection has historically been performed and recorded manually.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments disclosed herein provide for a quality control and inventory system for metal fabrication projects comprising a plurality of material data comprising a plurality of materials input via a user interface to a database in communication with a computing device via a server. The plurality of material data includes a piece mark to specify each item of the plurality of materials. A plurality of quality control inspection data includes a plurality of quality control tests and associated with a result of the quality control inspection test.

The system allows for the recordation of materials through the acquisition, transport, storage, and quality control inspections throughout a facility, such as a metal fabrication shop. Raw materials, tools, and other resources utilized by metal fabricators are inspected for integrity to ensure they are consistent with industry specifications and performance standards to ensure the project will result eventually pass structural inspections following fabrication. The system also allows for the management of materials data from a remote location without the need to consult paper filing systems.

In one aspect, an inventory module records the plurality of material data and stores the material data in the database.

In one aspect, the material data is further comprised of project data comprising acquisition of the material, inventory of the material, storage of the material, and quality control inspection of the material.

In one aspect, a quality control inspection module indicates a quality control test to perform on each of the plurality of materials.

In one aspect, the quality control inspection module determines a quality control protocol associated with a quality control test for each of the plurality of materials.

In one aspect, a report generation module generates an inventory report for the plurality of materials.

In one aspect, the report generation module generates a quality control inspection report from the result and to associate the result with each of the plurality of materials.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a screenshot of the quality control user interface, according to some embodiments;

FIG. 3 illustrates a block diagram of the server engine and associated modules, according to some embodiments;

FIG. 4 illustrates a block diagram of the inspection system, according to some embodiments;

FIG. 5 illustrates a screenshot of the inspection rate interface, according to some embodiments; and

FIG. 6 illustrates a flowchart for a method of inventorying and associating quality control data to a plurality of materials, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a metal fabrication inspection and record system to allow metal fabricators, project managers, inspectors, or other individuals to manage various aspects of a metal fabrication process. The system will provide an inventory system for various materials utilized during the processes of metal fabrication. The system will also provide a quality control inspection database wherein users can enter inspection data.

The system allows for the recordation of quality control inspections throughout a facility, such as a metal fabrication shop. Raw materials, tools, and other resources utilized by metal fabricators are inspected for integrity to ensure they are consistent with industry specifications and performance standards and that the resulting product will pass structural inspections following fabrication. Tools and other resources such as consumables are inspected to ensure they are maintained and are functioning properly based on manufacturer standards and guidelines.

As used herein, the term “user” may refer to fabricators who utilize the system to determine if the material, tool, or resource has been inspected for quality and who utilize the material, tool, or resource to perform a task, such as tasks related to metal fabrication. The term “user” may also refer to a person who performs the quality control inspection task or inventories the various materials, tools, and resources in the system where they are then stored in the database.

As used herein, the term “material” may refer to raw materials, tools, or similar resources used in the various processes of metal fabrication. The terms “tools” and “resources” may refer to consumable items or reusable resources, tools, and utilities.

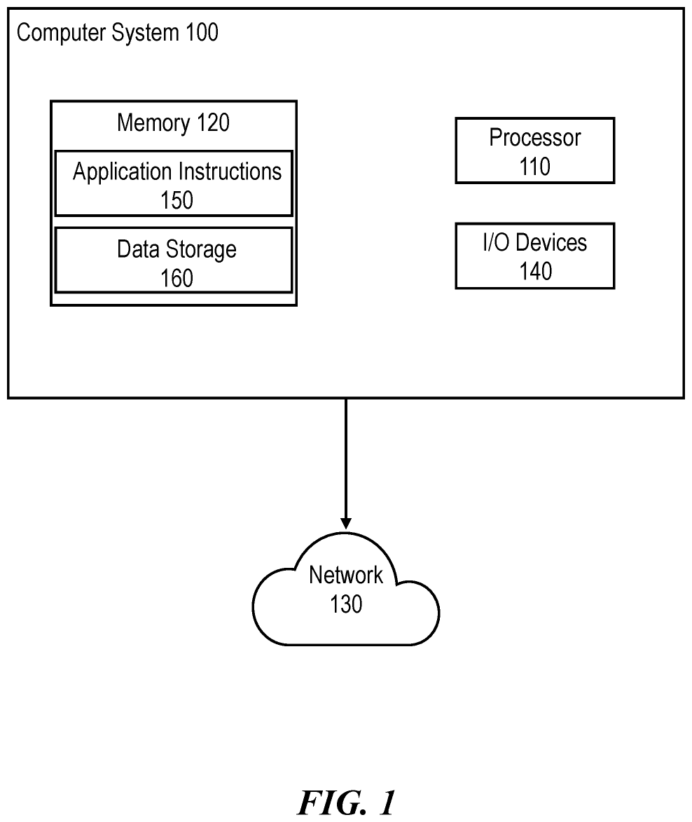

FIG. 1 illustrates a computer system 100, which may be utilized to execute the processes described herein. The computing system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

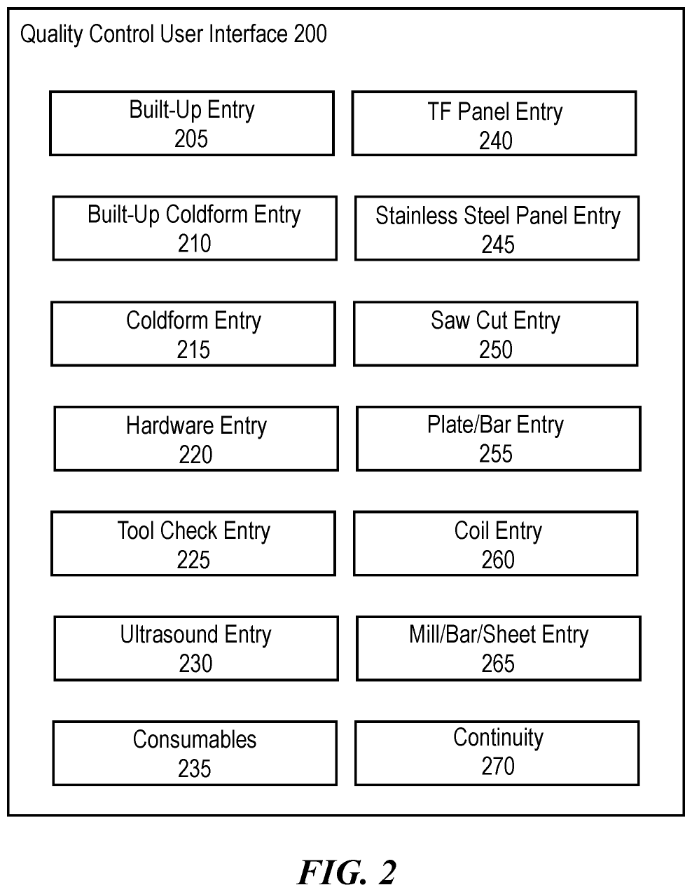

FIG. 2 illustrates an exemplary quality control user interface 200 wherein the user has a plurality of selectable tabs to enter quality control information related to various materials, tools, or resource types. For example, the quality control system may allow for built-up entry 205, built-up coldform entry 210, coldform entry 215, hardware entry 220, tool check entry 225, ultrasound entry 230, consumables 235, TF panel entry 240, stainless steel panel entry 245, saw cut entry 250, plate/bar entry 255, coil entry 260, mill/bar/sheet entry 265, and continuity 270. Selecting any of the plurality of selectable tabs allows the user to input quality control data such as whether or not the material, tool, or resource has been inspected, the time of the inspection, who performed the inspection, and if the inspection was successful or unsuccessful. With this information, the user can determine if a material, tool, or other resource is able to be used at that time.

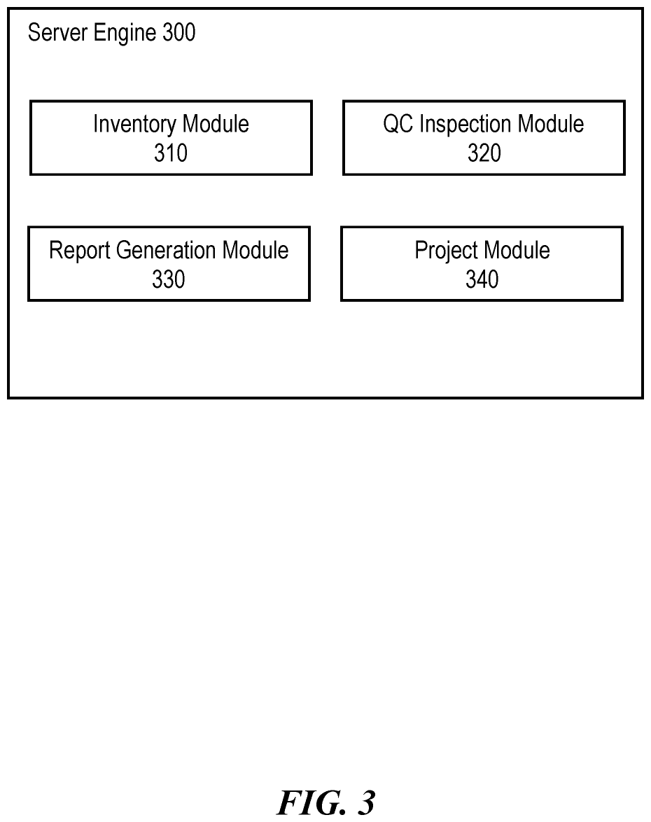

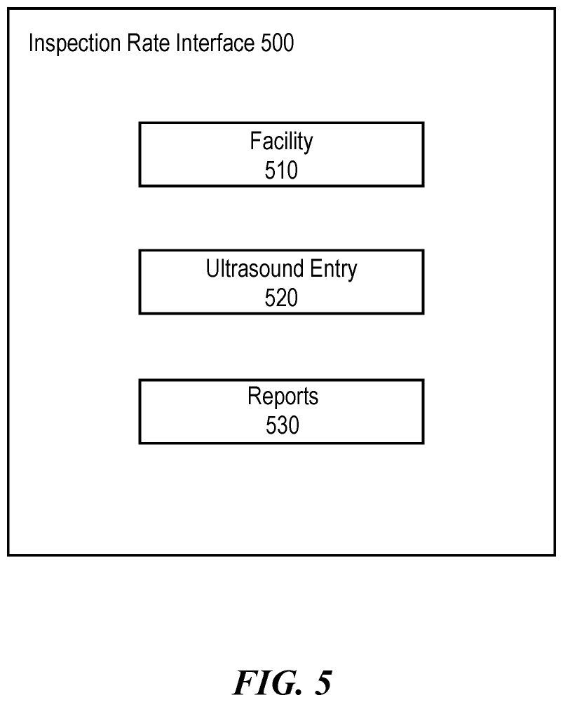

FIG. 3 illustrates the server engine 300 and associated modules to perform the various functionalities of the system described herein. An inventory module 310 processes inventory data input by the user, and inventories each material data in the database for user interactions. The inventory module may also permit the user to search the inventory for a material item or set of material items. The inventory module 310 may intake material data, including a material name, classification, piece mark, and quality inspection data related to the material. A quality control inspection module 320 allows the user to input various quality control data, as shown in FIG. 5. The quality control inspection module may comprise fabricator-specified data regarding inspection processes, equipment, and applicable standards. In other words, the fabricator may specify what methods are used to verify that a part has been made to designer specification and the standards used to conduct inspections. A report generation module 330 processes the quality control data and inventory data and generates a report which is viewable by the user. A project module 340 may be provided to generate project data, including necessary materials and inspection protocols for a particular project. The project module 340 may also aid in tracking and monitoring materials through the acquisition, transport, delivery, inventory, inspection, and fabrication processes.

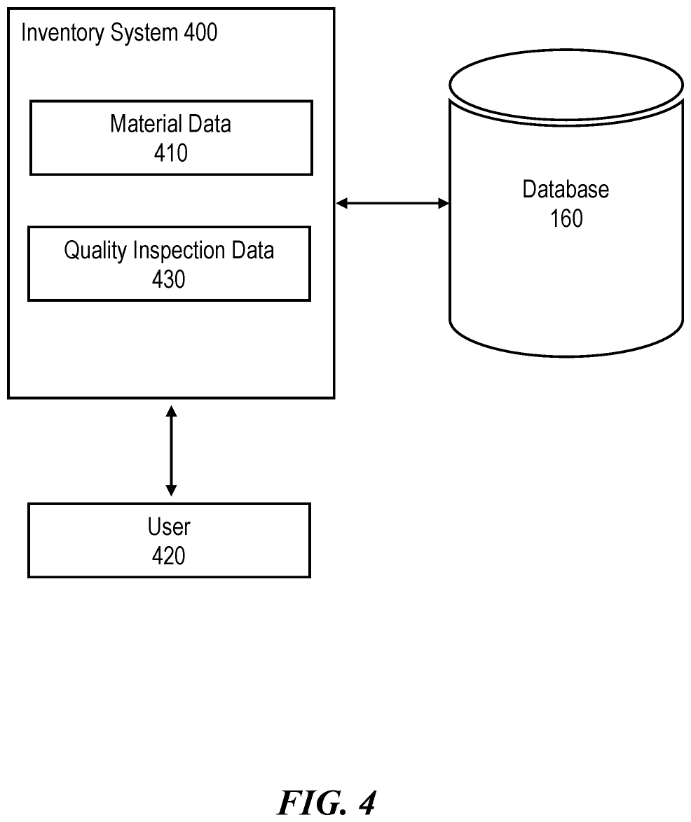

FIG. 4 illustrates a block diagram of the inventory system 400 and material data 410 utilized by the system and displayed to the user 420. The material data 410 is stored in the database 160, which can be accessed by the server to provide the material data on the display of the computing device. Material data may include the material type, material name, a piece mark associated with the material, project names associated with the material, and other material data known in the arts. The material may be associated with a particular location, user, project, or a purpose associated with the material. Quality inspection data 430 may include various inspection protocols for each material, quality inspection results, or users associated with a quality inspection performed on the material.

In reference to FIG. 5, an inspection rate interface 500 is illustrated in an exemplary embodiment. The user may select a facility (i.e., a job site or similar physical location) via a facility tab 510 and then select an ultrasound entry tab 520 and a reports tab 530, each corresponding to the selected facility tab 510.

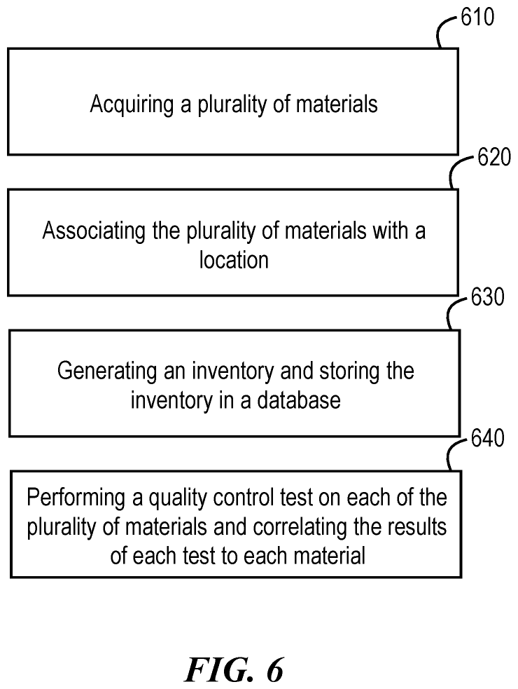

FIG. 6 illustrates a flowchart for a method for performing quality control and inventorying for metal fabrication projects comprising the steps of acquiring a plurality of materials in step 610 and associating the plurality of materials with a location in step 620. The location may include a project name or project site at which the materials will be utilized. In step 630, an inventory is generated and stored in a database in communication with a computing device via a server. In step 640, a quality control test is performed on each of the plurality of materials and is correlated to a result of the quality control test with each of the plurality of materials.

Various forms of quality control inspections may be performed, which can be separated into two categories: nondestructive testing and destructive testing. Nondestructive testing may include dye-penetrant, magnetic particle, radiographic, and ultrasonic inspection. Destructive testing may also be utilized when appropriate.

Materials data may contain information relating to materials that may be used to fabricate a part design model and may be used as a reference tool for designers, analysts, and fabricators. Materials data may contain property data as well as applications data. For example, materials data may have an entry for a steel alloy identifying properties such as elastic modulus, tensile strength, hardness, machinability, ductility, or other properties. Materials data may also contain applications data for the titanium alloy, such as its limitations when used in a high oxygen environment.

In some embodiments, the system provides a record system for recording inventory for a plurality of materials, such as materials commonly used in metal fabrication. The record system includes a plurality of input fields wherein the user may input one or more materials and indicate whether or not the material has passed an inspection performed by the fabricator, an inspector, or the like.

In some embodiments, the user may enter whether or not an ultrasonic test has been completed for each material in the record system. The user may also enter results of the ultrasonic test, such as by providing a pass/fail indication or by entering data from the ultrasonic test.

In some embodiments, the user may utilize the record system to a plurality of information, including a job number to indicate a particular fabrication project. The user may also enter a piece mark for each material during a fabrication project.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A quality control and inventory system for metal fabrication projects, the system comprising:
a plurality of material data comprising a plurality of materials, the plurality of material data input via a user interface to a database in communication with a computing device via a server; and
a plurality of quality control inspection data associated with each of the plurality of material data to indicate a result of a quality control inspection test.

2. The system of claim 1, wherein the material data is comprised of a plurality of materials and a plurality of tools.

3. The system of claim 2, further comprising an inventory module to record the plurality of material data and store the material data in the database.

4. The system of claim 3, wherein the material data is further comprised of project data including data regarding acquisition of the material, inventory of the material, storage of the material, and quality control inspection of the material.

5. The system of claim 1, further comprising a quality control inspection module to indicate a quality control test to perform on each of the plurality of materials.

6. The system of claim 5, wherein the quality control inspection module determines a quality control protocol associated with a quality control test for each of the plurality of materials.

7. The system of claim 1, further comprising a report generation module to generate an inventory report for the plurality of materials.

8. The system of claim 7, wherein the report generation module generates a quality control inspection report from the result and to associate the result with each of the plurality of materials.

9. A quality control and inventory system for metal fabrication projects, the system comprising:
a plurality of material data comprising a plurality of materials, the plurality of material data input via a user interface to a database in communication with a computing device via a server, the plurality of material data comprising a piece mark to specify each item of the plurality of materials; and
a plurality of quality control inspection data comprising a plurality of quality control tests and associated with a result of the quality control inspection test.

10. The system of claim 9, wherein the material data is comprised of a plurality of materials and a plurality of tools.

11. The system of claim 10, further comprising an inventory module to record the plurality of material data and store the material data in the database.

12. The system of claim 12, wherein the material data is further comprised of project data including data regarding acquisition of the material, inventory of the material, storage of the material, and quality control inspection of the material.

13. The system of claim 9, further comprising a quality control inspection module to indicate a quality control test to perform on each of the plurality of materials.

14. The system of claim 13, wherein the quality control inspection module determines a quality control protocol associated with a quality control test for each of the plurality of materials.

15. The system of claim 9, further comprising a report generation module to generate an inventory report for the plurality of materials.

16. The system of claim 15, wherein the report generation module generates a quality control inspection report from the result and to associate the result with each of the plurality of materials.

17. The system of claim 9, wherein the quality control test is a nondestructive test.

18. A method for performing quality control and inventory for metal fabrication projects, the method comprising the steps of:
acquiring a plurality of materials;
associating the plurality of materials with a location;
generating an inventory stored in a database in communication with a computing device via a server;
performing a quality control test on each of the plurality of materials; and
correlating a result from the quality control test with each of the plurality of materials.

19. The method of claim 18, further comprising the step of using an inventory module to record the plurality of material data and store the material data in the database.

20. The method of claim 18, wherein the quality control test is a nondestructive test.
